(19) United States
(12) Patent Application Publication
(10) Pub. No.: US 2025/0195300 A1
(43) Pub. Date: Jun. 19, 2025

(54) TRAIN COACH LAYOUT ADAPTED FOR WHEELCHAIR ACCESS TO CABIN

(71) Applicant: ALSTOM Holdings, Saint-Ouen-sur-Seine (FR)

(72) Inventors: Thomas MEYER, Berlin (DE); Thomas STRAUCH, Berlin (DE); Nicole MICHEL, Potsdam (DE); Thomas PIETSCHMANN, Koenigs Wusterhausen (DE)

(21) Appl. No.: 18/650,913

(22) Filed: Apr. 30, 2024

(30) Foreign Application Priority Data
Dec. 18, 2023 (EM) 015044826

(51) Int. Cl. A61G 3/08; B61D 1/00

(52) U.S. Cl. CPC A61G 3/0808; B61D 1/00

(57) ABSTRACT

A train coach layout adapted for wheelchair access to a cabin of a train coach includes a plurality of cabins. The location of the cabin is different from an extremity of the train coach. The train coach layout includes a partition wall section of the train coach arranged with a triangular shape extending from a corridor of the train coach towards the cabin accessible by wheelchair. Each of two adjacent cabins include one partition wall corresponding to one side of the triangular shape. The cabin also includes a cabin access door, has dimensions and orientations to both allow movement of wheelchair and minimize loss of space in cabin.

The present disclosure concerns a train coach layout adapted for wheelchair access to a cabin accessible by wheelchair of said train coach, said train coach comprising a plurality of cabins, the location of said cabin accessible by wheelchair being different from an extremity of said train coach.

The present disclosure also relates to a train coach presenting said train coach layout.

The present disclosure also relates to a train comprising at least one of train coach of the above type.

The present disclosure also relates to a method for sizing a train coach layout adapted for wheelchair access to a cabin accessible by wheelchair of said train coach.

### BACKGROUND

The present disclosure relates to layouts of rolling stocks and especially to a layout providing accessibility to train coach (i.e. train car or train carriage) for persons with reduced mobility.

More specifically, the present disclosure relates to accessibility to sleeping cabin (i.e. compartment) of train coach.

Indeed, the turning circle required by the international union of railways UIC for wheelchair users is not achievable within the narrow corridor with conventional design, with no possibility to turn around in it or to pass each other. Wheelchair user would have to leave the narrow corridor backwards.

More precisely, the wheelchair access from an aisle (i.e. corridor) to a compartment depends on the width of the aisle. Technical specifications for interoperability (TSI) relating to persons with reduced mobility (PRM) defines the minimum requirements concerning combinations of width of the aisle and width of the doorway, such requirements leading either to an increased width of the aisle not necessary for wheelchair and passenger traffic and a loss of space for compartments (i.e. cabins), or very large doors with loss of space in the compartment (i.e. cabin) and a lot of other problems in conjunction with oversized doors.

In this field of accessibility to sleeping cabin of train coach, various solutions have been proposed.

For example, as can be seen in the Caledonian sleeper train, the accessible type cabins are localized at each extremity of the car.

The article accessible by the following URL: transportandtravel.wordpress.com/2022/02/25/nexgen_night_trains/#new-principles_discloses a train coach layout with compartments dedicated for travelers with restricted mobility, especially the compartment Q of said layout is reachable by a passenger in a wheelchair and involves a loss of space in the train coach.

### SUMMARY

An aim of the present disclosure is therefore to address the problems of optimizing the layout of train coach to improve cabin accessibility by avoiding the layouts proposed by the prior art based on extremity location of accessible coach or based on a layout involving a loss of space.

To this end, an object of the present disclosure is a train coach layout adapted for wheelchair access to a cabin accessible by wheelchair of said train coach, said train coach comprising a plurality of cabins, the location of said cabin accessible by wheelchair being different from an extremity of said train coach, wherein said train coach layout comprises a partition wall section of the train coach arranged with a triangular shape extending from the corridor of said train coach towards said cabin accessible by wheelchair, said triangular shape allowing more space for the doorway to the cabin accessible by wheelchair, each of two adjacent cabins comprising said cabin accessible by wheelchair presenting one partition wall corresponding to one side of said triangular shape, said partition wall of said cabin accessible by wheelchair comprising a cabin access door and presenting dimensions and orientation configured to both allow movement of wheelchair and minimize loss of space in cabin.

Advantageously, the accessibility type cabin could be thus positioned anywhere along the coach (i.e. the car). In particular, the train coach layout according to the present disclosure, with a partition wall section of the train coach arranged with a triangular shape, said partition wall section of the train coach arranged with a triangular shape being also called in the following “retracted partition wall”, provides improvement of cabin accessibility, in particular sleeping cabin accessibility, in the middle of the vehicle for wheelchair. More precisely, said train coach layout generates movement space for persons with reduced mobility PRM (persons with handicap, rollator, or pram) for a trouble-free passenger flow.

In comparison with the prior art solutions, according to the solution of the present disclosure, smaller door widths and space savings through shorter cabins are achieved with an increase in comfort, as further detailed in the following. Passenger flow in the corridor is thus improved.

In other words the solution of the present disclosure achieves provision of space for wheelchair users to turn and gain access to sleeping cabins in the middle of the train carriage. Thus, the present disclosure does not only solve the accessibility by wheelchairs, since it provides also a space saving solution for turning wheelchairs and the compartments (i.e. cabins) can be accessed forward and backward.

In addition, it has to be noted that according to an additional benefit this spatial principle can be used for all compartments that are accessed with larger train equipment such as trolleys, serving trolleys, etc.

According to particular embodiments, the train coach layout comprises one or more of the following characteristics, taken separately or in any technically feasible combination:
said triangular shape is isosceles, the base of the isosceles triangle being a portion of the proximal longitudinal boundary of said corridor in relation to said two adjacent cabins, said corridor extending longitudinally along the direction of travel of said train coach, the two equal sides of said isosceles triangle corresponding to said partition walls comprising a cabin access door of said two adjacent cabins;
said cabin accessible by wheelchair is a sleeping cabin;
said dimensions depend on a predetermined couple formed on the one hand by the corridor clearway width and on the other hand by the door usable width or a perpendicular corridor clearway width, said predetermined couple being defined by a technical specifications for interoperability relating to persons with reduced mobility;
the door width of said cabin accessible by wheelchair is obtained using said couple and a predetermined turning circle associated to the wheelchair dimensions.

The present disclosure also relates to a train coach as such presenting the train coach layout, as above described.

According to particular embodiments, the train coach comprises one or more of the following characteristics, taken separately or in any technically feasible combination:
the cabin access door of said cabin accessible by wheelchair is an automatic door openable via an access system;
said cabin access door of said cabin accessible by wheelchair is an upward-opening swing door or a curved sliding door when viewing from top.

The present disclosure also relates to a train as such comprising at least one train coach, as above described.

The present disclosure also relates to a method for sizing a train coach layout adapted for wheelchair access to a cabin accessible by wheelchair of said train coach, said method taking into account at least:
a predetermined couple formed on the one hand by the corridor clearway width and on the other hand by the door usable width or a perpendicular corridor clearway width, said predetermined couple being derived using a technical specifications for interoperability relating to persons with reduced mobility, and
a predetermined turning circle associated to the wheelchair dimensions.

### BRIEF DESCRIPTION OF THE DRAWINGS

The present disclosure and its advantages will be better understood upon reading the following detailed description of a particular embodiment, given solely by way of a non-limiting example, wherein this description is made with reference to the appended drawings, wherein:

FIG. 1 illustrates the proposed train coach layout according to the present disclosure;

FIG. 2 illustrates a step of a method for sizing a train coach layout adapted for wheelchair access to a cabin accessible by wheelchair of said train coach, according to the present disclosure.

### DETAILED DESCRIPTION

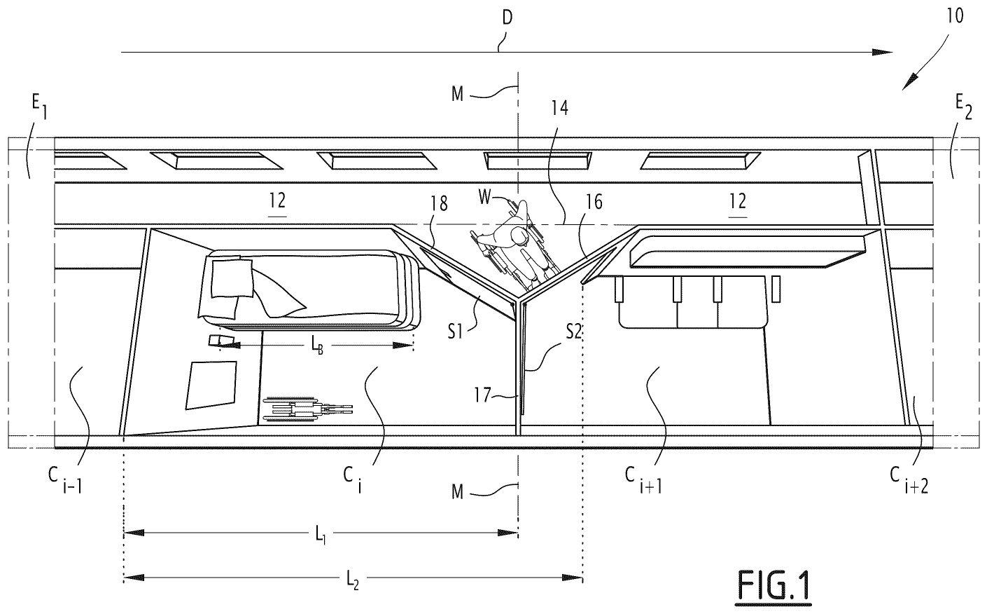

An example of train coach (i.e. train car or train carriage) layout 10 according to the present disclosure is illustrated by FIG. 1.

More precisely, considering the direction D of travel of a train coach of a train, said train coach comprises, from a first extremity E₁ to a second extremity E₂, a plurality of cabins Cᵢ₋₁, Cᵢ, Cᵢ₊₁, Cᵢ₊₂. In particular, on FIG. 1, contiguous cabins Cᵢ and Cᵢ₊₁ are located on both sides of the middle M of said train coach. The cabin Cᵢ is a sleeping cabin.

A corridor 12 (i.e. an aisle) serves the whole set of cabins of said train coach.

According to the present disclosure said train coach layout is adapted for wheelchair W access to said sleeping cabin Cᵢ, not located in the extremity of said train coach, by comprising a partition wall section arranged with a triangular shape extending from the corridor 12 of said train coach towards a common access area of contiguous cabins Cᵢ and Cᵢ₊₁.

More precisely, according to an optional aspect said triangular shape is isosceles, the base 14 of the isosceles triangle being a portion of the proximal longitudinal boundary of said corridor 12 in relation to said two adjacent cabins Cᵢ and Cᵢ₊₁, said corridor extending longitudinally along the direction D of travel of said train coach, the two equal sides of said isosceles triangle corresponding to said partition walls 16 and 18 comprising, in the example of FIG. 1, a cabin access door of said two adjacent cabins Cᵢ and Cᵢ₊₁.

It has to be noted that to provide the access of PRM sleeping cabins, the train coach layout according to the present disclosure should always present such a triangular shape architecture either with one entrance door to one of the compartments (not represented) or even both entrance doors as represented in FIG. 1 in partition walls 16 and 18 to both compartments (i.e. cabins). The example illustrated by FIG. 1 with the “mirrored” compartments (i.e. cabins) and door entrance, on both sides of the partition wall 17 acting as a mirror, is the most pace saving solution and practical solution.

The vertex of this triangular shape opposite the base 14 corresponds to the corridor proximal extremity of the partition wall 17 separating said two adjacent cabins Cᵢ and Cᵢ₊₁.

In other word said partition walls 16, 17 and 18 arranged in a “Y” form.

Said triangular shape made of segments 14, 16 and 18, allows more space for the doorway to the cabins Cᵢ and Cᵢ₊₁ accessible by wheelchair.

In FIG. 1, the two adjacent cabins Cᵢ and Cᵢ₊₁ are cabins accessible by wheelchair presenting one partition wall, 18 and 16 respectively, corresponding to one side of said triangular shape, each partition wall 18 and 16 of said cabins Cᵢ and Cᵢ₊₁ accessible by wheelchair comprising a cabin access door, S₁ and S₂ respectively and presenting dimensions and orientation, which are specifically configured to both allow movement of wheelchair and minimize loss of space in compartment.

More precisely, in the example of FIG. 1, said cabin Cᵢ is a bedroom, the bed presenting a length L_{B}, whereas the contiguous cabin Cᵢ₊₁ is a sitting room.

Such a triangular corridor design thus optimises the space obtained for double cabins or contiguous rooms with shared use of the corridor.

Indeed, the main advantage of the door arrangement with a “retracted partition wall” (i.e. said partition wall section of the train coach arranged with a triangular shape) is that the total length of the doors in longitudinal car (i.e. coach) direction D is reduced.

Indeed, when having the doors arranged along a straight wall between cabins Cᵢ₋₁, Cᵢ, Cᵢ₊₁, Cᵢ₊₂ and corridor 12, the doors consume more length in longitudinal direction D.

In comparison with the sleeping cabin Cᵢ length, represented by Lᵢ according to the present disclosure, in order to provide a proper bed length L_{B} the sleeping cabin Cᵢ length, represented by L₂ when having the doors arranged along the longitudinal direction D would have to be extended to fulfil the requirements of the TSI PRM (as described in the following) with loss of space in other car areas (i.e. in other cabins).

According to an optional aspect, the dimensions of the partition wall 16 and 18 and/or of the cabin access door, S₁ and S₂ depends on a predetermined couple formed on the one hand by the corridor clearway width and on the other hand by the door usable width along the longitudinal direction D of travel of said train coach or a perpendicular corridor clearway width, said predetermined couple being derived from a technical specifications for interoperability TSI relating to persons with reduced mobility PRM.

Such a couple is for example extracted from table K1 of the TSI PRM of the corridor width for wheelchair accessible areas in Rolling stock:

| | | | | | | |
|---|---|---|---|---|---|---|
| Corridor | 1200 | 1100 | 1000 | 900 | 850 | 800 |
| clearway | | | | | | |
| width (mm) | | | | | | |
| Door usable | 800 | 850 | 900 | 1000 | 1100 | 1200 |
| width or a | | | | | | |
| perpendicular | | | | | | |
| corridor | | | | | | |
| clearway | | | | | | |
| width (mm) | | | | | | |

According to an optional aspect, the cabin access doors S₁ and S₂ of said cabins Cᵢ and Cᵢ₊₁ accessible by wheelchair are automatic doors openable via an access system. Indeed, for wheelchair W users, automatic doors are required for wide entrances in order to meet ergonomic requirements.

According to a further optional aspect, said cabin access doors S₁ and S₂ are upward-opening swing doors, which permits weight reduction by avoiding heavy sliding doors and cost saving due to simple door technology, locking technology and access system identical to the other compartment doors.

As an alternative, said cabin access doors S₁ and S₂ are curved sliding doors when viewing from top.

On FIG. 1, it has to be noted that the cabin access door S₁ of said cabins Cᵢ accessible by wheelchair is closed whereas the cabin access door S₂ of said cabins Cᵢ₊₁ accessible by wheelchair is open.

As a result, the train coach layout of FIG. 1 provides turning area for passengers with and without handicap (e.g. wheelchair drivers) and thus a better passenger flow and an easier access to the two cabins Cᵢ and Cᵢ₊₁.

Moreover, the train coach according to the present disclosure as illustrated by FIG. 1 presents optimised door size and less effort than with sliding doors, and space saving compared to conventional solutions.

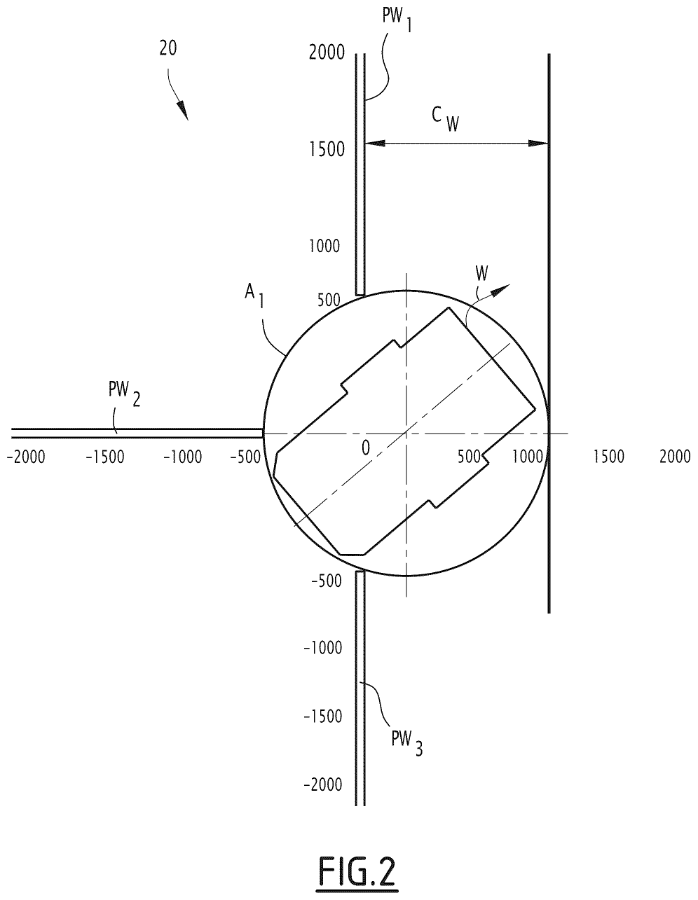

FIG. 2 is a schematic top view illustrating a step of a method for sizing a train coach layout adapted for wheelchair access to a cabin accessible by wheelchair of said train coach, according to the present disclosure.

Said method takes into account at least:
a predetermined couple formed on the one hand by the corridor clearway width and on the other hand by the door usable width or a perpendicular corridor clearway width, said predetermined couple being derived using a technical specifications for interoperability relating to persons with reduced mobility, and
a predetermined turning circle associated to the wheelchair dimensions.

More precisely, FIG. 2, is obtained by considering a couple derived from the above table K1, wherein the corridor clearway width C_{w} is equal do 945 mm and wherein the door (not represented) usable width along the longitudinal direction D of travel of said train coach would be equal to 955 mm.

Such a couple 945/955 is obtained by a linear function between the two couples 100/900 and 900/1000 of the above table K1 when considering the corridor clearway width C_{w} on the ordinate and the door usable width along the longitudinal direction D of travel on the abscissa.

Starting from such a couple, then sizing a train coach layout adapted for wheelchair access to a cabin accessible by wheelchair of said train coach, comprises taking into account a predetermined turning circle A₁ associated to the wheelchair W dimensions.

More precisely, in FIG. 2, it is, for example, considered that the wheelchair W presents a standard length of 1250 mm, but an extended length (not represented) can also be considered corresponding, for example, to a customer specific wheelchair length of 1400 mm.

Each wheelchair length is associated with its proper turning circle A₁. For example in FIG. 2, the turning circle A1 is the turning circle associated with a wheelchair W standard length of 1250 mm.

Then, the position and dimensions of the partition walls PW₁, PW₂, PW₃, can be optimised for forming, according to the present disclosure, the partition wall section of the train coach arranged with a triangular shape, also called “retracted partition wall” with respect to the corridor, by making sure, thanks to the turning circle A₁, that a person with reduced mobility using a wheelchair W can access easily each cabin defined by said partition walls PW₁, PW₂, PW₃, as represented by FIG. 2.

Thus, the train coach layout, the train coach, the train, and the method for sizing a train coach layout of the present disclosure provide improvement of cabin accessibility for wheelchair, and especially of sleeping cabin accessibility for wheelchair.

More precisely, the present disclosure allows modifying of the train layout to be able to put sleeping cabin in the middle of the vehicle and not at the end of the vehicle. The partition walls have been assembled in a triangular shape to ease the turn around for a wheelchair and facilitate accessibility to the sleeping cabin.

Said present disclosure provides in addition an optimum use of space with increased comfort, avoiding sliding doors, while being compliant with the UIC requirement.

What is claimed is:

1. A train coach layout adapted for wheelchair access to a cabin accessible by wheelchair of a train coach, the train coach comprising a plurality of cabins, a location of the cabin accessible by wheelchair being different from an extremity of the train coach, the train coach layout comprising:
a partition wall section of the train coach arranged with a triangular shape extending from a corridor of the train coach towards the cabin accessible by wheelchair, the triangular shape allowing more space for a doorway to the cabin accessible by wheelchair, each of two adjacent cabins comprising the cabin accessible by wheelchair presenting one partition wall corresponding to one side of the triangular shape, the partition wall of the cabin accessible by wheelchair comprising a cabin access door and presenting dimensions and orientation configured to both allow movement of wheelchair and minimize loss of space in cabin.

2. The train coach layout according to claim 1, wherein the triangular shape is isosceles, a base of the isosceles triangle being a portion of a proximal longitudinal boundary of the corridor in relation to the two adjacent cabins, the corridor extending longitudinally along a direction of travel of the train coach, the two equal sides of the isosceles triangle corresponding to the partition walls comprising a cabin access door of the two adjacent cabins.

3. The train coach layout according to claim 1, wherein the cabin accessible by wheelchair is a sleeping cabin.

4. The train coach layout according to claim 1, wherein the presented dimensions of the partition wall depend on a predetermined couple formed on the one hand by a corridor clearway width and on the other hand by a door usable width or a perpendicular corridor clearway width, the predetermined couple being defined by a technical specifications for interoperability relating to persons with reduced mobility.

5. The train coach layout according to claim 4, wherein a door width of the cabin accessible by wheelchair is obtained using the predetermined couple and a predetermined turning circle associated to dimensions of the wheelchair.

6. A train coach comprising the train coach layout according to claim 1.

7. The train coach according to claim 6 wherein the cabin access door of the cabin accessible by wheelchair is an automatic door openable via an access system.

8. The train coach according to claim 7 wherein the cabin access door of the cabin accessible by wheelchair is an upward-opening swing door or a curved sliding door when viewing from top.

9. A train comprising at least one of the train coach according to claim 6.

10. A method for sizing a train coach layout adapted for wheelchair access to a cabin accessible by wheelchair of a train coach, the method comprising:
sizing the train coach layout to take into account a predetermined couple formed on the one hand by a corridor clearway width and on the other hand by a door usable width or a perpendicular corridor clearway width, the predetermined couple being derived using a technical specifications for interoperability relating to persons with reduced mobility; and
sizing the train coach layout to take into account a predetermined turning circle associated to dimensions of the wheelchair.
